(19) United States
(12) Patent Application Publication
(10) Pub. No.: US 2023/0043561 A1
(43) Pub. Date: Feb. 9, 2023

(54) Transportable Slurry Box System

(71) Applicant: Ryan Peterkin, Nikiski, AK (US)

(72) Inventor: Ryan Peterkin, Nikiski, AK (US)

(73) Assignee: Magtech Alaska, LLC, Kenai, AK (US)

(21) Appl. No.: 17/579,763

(22) Filed: Jan. 20, 2022

Related U.S. Application Data
(63) Continuation of application No. 17/531,989, filed on Nov. 22, 2021.
Application No. 17/531,989 is a continuation-in-part of application No. 17/396,403, filed on Aug. 6, 2021.

(51) Int. Cl. B60P 3/22; B65D 88/74; B65D 81/38; B65D 90/06; B65D 81/20; B65D 90/18

(52) U.S. Cl. CPC B60P 3/2295; B60P 3/2205; B65D 88/744; B65D 88/748; B65D 81/3813; B65D 90/06; B65D 81/2015; B60P 3/226; B65D 90/18

(57) ABSTRACT

A system for using a heated portable vacuum slurry box to efficiently store and transport material including drill cuttings from gas and oil well sites. The slurry box generally includes a vacuum tank, a structure attached to the tank, a vertical tailgate, and a hook for pulling the slurry box onto a vehicle. The features allow for the slurry box to meet space restriction requirements at a well site while functioning within the environmental conditions of winter and summer seasons. The system includes a preferred method to unload the slurry box.

### CROSS-REFERENCE TO RELATED APPLICATION(S)

This application claims the priority as a continuation-in-part of U.S. Nonprovisional patent application Ser. No. 17/531,989, (01450-PET) filed Nov. 22, 2021, which is a continuation-in-part of U.S. Nonprovisional patent application Ser. No. 17/396,403, (01393-PET) filed Aug. 18, 2021, the contents of which both are hereby incorporated by reference in its entirety.

### FIELD OF TECHNOLOGY

This disclosure relates generally to technology for roll-off self-contained cutting boxes for heated slurry transport, receiving, and dumping in cold climates with freezing temperatures.

### BACKGROUND

Drill cuttings are produced during drilling of oil wells and gas wells. The drill cuttings are carried to the surface by a drilling fluid circulating up from the drill bit. The drill cuttings are separated from the drilling fluid so the recycled drilling fluid may be reused during the drilling process. The separated drill cuttings along with a portion of the drilling fluid and other fluids form a cuttings slurry that is often transported to a vacuum tank for holding until full. Once the tank is full of the cuttings slurry, the slurry cuttings is transported to a disposal facility.

One problem with conventionally transporting slurry cuttings in a vacuum tank is that the slurry cuttings may freeze in cold weather environments such as Alaska, cold climate states and Canada, making it difficult to unload the slurry cuttings from the vacuum box. To solve this problem one solution is to provide heat energy to keep the slurry cuttings from freezing.

Vacuum tanks must be removed from oil and gas well sites in a timely manner such to not impede the function of a drilling rig at an oil or gas well site. Such sites are limited in space and storing many vacuum tanks on the oil or gas well site is not possible with current vacuum tank systems. Further portable slurry boxes often do not fit the requirements to be efficiently emptied at disposal facilities. In the warm summer months, poor road conditions cause excess wear on equipment. Transporting vacuum tanks with heating functions over summer roads during times of the year when the heating functions are unneeded unnecessarily causes wear on such equipment.

### SUMMARY

A system for transporting slurry cuttings for disposal between an oil rig site and a disposal facility according to one disclosed non-limiting embodiment of the present disclosure includes a slurry box comprised of a structure that contains a vacuum tank that can hold a vacuum pressure, the vacuum tank comprises an inlet port and a vacuum port, the slurry box positioned to receive slurry cuttings at an oil rig site expressed from an oil rig through a slurry cutting outlet connected to the inlet port in response to a vacuum connected to the vacuum port at the oil rig site such that the slurry cuttings are expressed into the vacuum tank when under the vacuum pressure from the vacuum source, the vacuum source disconnected from the vacuum port when the vacuum tank is filled to a desired level with slurry cuttings; that are expressed into the vacuum tank when under the vacuum pressure; wherein the slurry box is sized to be unloaded and loaded from a vehicle, the vehicle operable to transport the slurry box between the oil rig site and a disposal facility at which a vertical tailgate of the slurry box is opened vertically to dump the slurry cuttings from the vacuum tank by tilting the slurry box relative to the ground when the vertical tailgate is open.

A further embodiment of any of the foregoing embodiments includes a second slurry box, the slurry box is stackable upon a second slurry box to form a slurry box stack.

A further embodiment of any of the foregoing embodiments in which the vehicle is a roll-off vehicle.

A further embodiment of any of the foregoing embodiments in which the vacuum source is a vacuum pump.

A further embodiment of any of the foregoing embodiments in which the vehicle is a truck-trailer.

A further embodiment of any of the foregoing embodiments in which the vehicle is a sled configured to be transported in snowy and icy conditions.

A further embodiment of any of the foregoing embodiments includes, wherein, wherein the oil rig site further comprises a storage location to place the slurry box stack.

A further embodiment of any of the foregoing embodiments in which the slurry box a hook point to which a cable from the vehicle is attached to transit the slurry box onto the vehicle via a wheel set on the structure.

A further embodiment of any of the foregoing embodiments in which the slurry box is unloaded at the disposal facility by first draining unconstrained fluid in the slurry cuttings by opening a port of the vacuum tank.

A further embodiment of any of the foregoing embodiments in which the slurry box a power unit within a mechanical bay of the slurry box, the power unit in communication with a system of warming tubes in the vacuum tank to heat the slurry cuttings in the vacuum tank to a temperature above freezing.

A further embodiment of any of the foregoing embodiments in which the power unit is removable from the mechanical bay.

A further embodiment of any of the foregoing embodiments in which the power unit is adapted to heat a fluid which is circulated through the system of warming tubes producing a heated fluid flow.

A further embodiment of any of the foregoing embodiments in which the vertical tailgate is attached to the structure with at least one tailgate hinge.

A further embodiment of any of the foregoing embodiments includes, a hydraulic cylinder attached to the tailgate and the structure around the vacuum tank, the hydraulic cylinder operable to open the tailgate.

A further embodiment of any of the foregoing embodiments includes, removing the slurry box from a stack of slurry boxes.

A further embodiment of any of the foregoing embodiments includes stacking the slurry box onto a stack of slurry boxes.

A further embodiment of any of the foregoing embodiments in which the structure facilities vertical stacking.

A further embodiment of any of the foregoing embodiments in which a wheel set on the structure.

A system for transporting slurry cuttings for disposal according to one disclosed non-limiting embodiment of the present disclosure includes a slurry box that is stackable upon a second slurry box to form a slurry box stack, the slurry box comprised of a structure that contains a vacuum tank, a power unit, a system of warming tubes, a mechanical bay, and a vertical tailgate, the vacuum tank comprises an inlet port a vacuum port the vertical tailgate pivotable to open and close vertically to dump the slurry cuttings, the power unit adapted to heat a fluid distributed through the system of warming tubes to heat the slurry cuttings in the slurry box to a temperature above freezing. A disposal facility at which the vertical tailgate of the slurry box is opened to dump the slurry cuttings from the vacuum tank by tilting the slurry box relative to the ground. A vacuum source connectable to the vacuum port when charging the vacuum tank while the vacuum tank is fluidly sealed from atmosphere. An oil rig site comprising a slurry cutting outlet, the slurry cuttings expressed from the oil rig through the slurry cutting outlet, the slurry cutting outlet fluidly sealed to the inlet port when the vacuum source is connected to the vacuum port, the slurry cuttings expressed into the vacuum tank when the vacuum tank is under the vacuum pressure, the vacuum source disconnected from the vacuum tank when the vacuum tank is filled to a desired level with slurry cuttings. A storage location at the oil rig site to place the slurry box stack, and a vehicle, the slurry box sized to be unloaded and loaded from the vehicle, the vehicle operable to transport the slurry box between the oil rig site and the disposal facility.

A further embodiment of any of the foregoing embodiments in which the vertical tailgate is attached to the structure with at least one tailgate hinge.

A further embodiment of any of the foregoing embodiments includes, a hydraulic cylinder attached to the tailgate and the structure around the vacuum tank, the hydraulic cylinder operable to open the tailgate.

A further embodiment of any of the foregoing embodiments in which each slurry box is 2.26 meters (89 inches) wide by 7.37 meters (290 inches) long.

A further embodiment of any of the foregoing embodiments in which the vehicle is a roll-off vehicle.

A further embodiment of any of the foregoing embodiments in which the vehicle is a truck-trailer.

A further embodiment of any of the foregoing embodiments in which the vehicle is a sled configured to be transported in snowy and icy conditions.

### BRIEF DESCRIPTION OF THE DRAWINGS

These and other features and advantages of the present invention will become more readily appreciated as the same becomes better understood by reference to the following detailed description when considered in connection with accompanying drawings, wherein:

FIG. 1 is a perspective view of an exemplary slurry box;

FIG. 2 is a perspective view of an exemplary slurry box mounted on a vehicle;

FIG. 3 is a perspective view of an exemplary slurry box displaced from a vehicle;

FIG. 4 is a top view of an exemplary slurry box;

FIG. 5 is a driver-side view of an exemplary slurry box;

FIG. 6 is a front view of the exemplary slurry box;

FIG. 7 is a rear view of the exemplary slurry box;

FIG. 8 is an exploded view showing how the power unit can be removed;

FIG. 9 is a perspective view of an exemplary slurry box showing the tailgate in the open position;

FIG. 10 is a sectional view of an exemplary jacketed flange;

FIG. 11 is a schematic view of an exemplary set of warming tubes;

FIG. 12 is a simplified block diagram showing a method in which a slurry box is used efficiently according to one disclosed non-limiting embodiment;

FIG. 13 is a schematic view of an exemplary slurry box connected at an oil rig;

FIG. 14 is a perspective view of two slurry boxes stacked on top of each other;

FIG. 15 is a simplified block diagram showing a method in which a slurry box is unloaded according to one disclosed non-limiting embodiment;

FIG. 16 is a side view of an exemplary slurry box in a raised position on a vehicle;

FIG. 17 is a perspective view of an exemplary slurry box and vehicle after the slurry box is placed on a ground surface.

### DETAILED DESCRIPTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

The slurry box as described in U.S. Nonprovisional patent application Ser. No. 17/531,989, filed Nov. 22, 2021, U.S. Nonprovisional patent application Ser. No. 17/396,403, filed Aug. 18, 2021, and the vacuum box as defined in U.S. Pat. No. 10,933,794 to Peterkin titled “Heated slurry transport system”, all contents of which are hereby incorporated by reference in its entirety and define the slurry box 101 as referenced in herein.

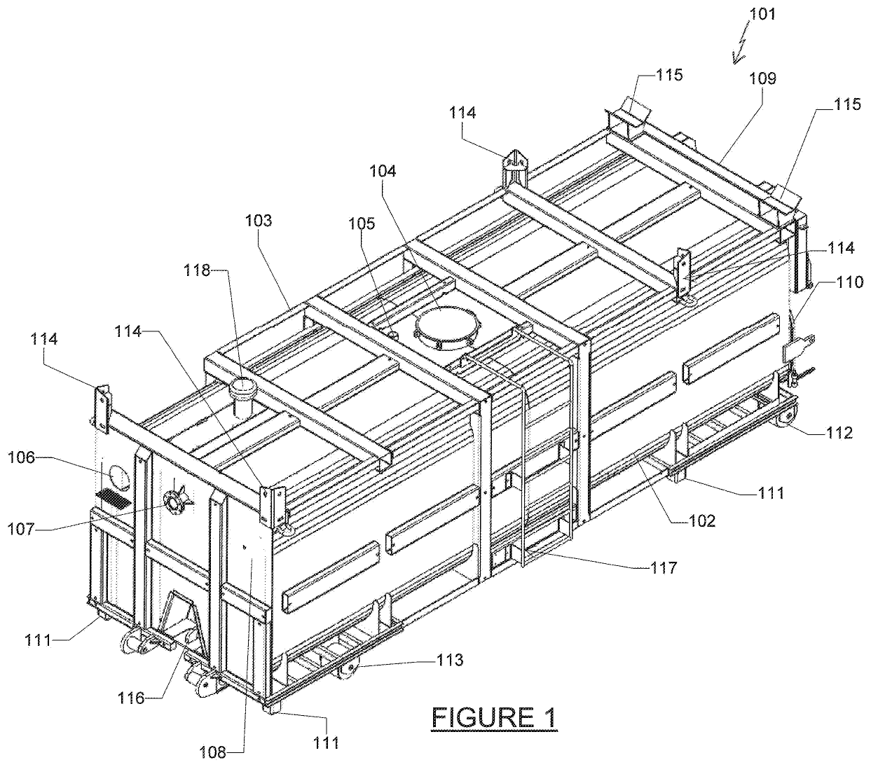

FIG. 1 is a perspective view of an exemplary slurry box 101. The slurry box 101 includes a vacuum tank 102, a structure 103, and a mechanical bay 106. The slurry box 101 has a front 108 and a rear 109. The vacuum tank 102 is attached to the structure 103. Attached to the vacuum tank 102 is a manhole 104 which can be opened to allow for a person to enter the vacuum tank 102 or to load or unload the vacuum tank 102. The vacuum tank 102 is such that it can withstand full or partial vacuum pressure. When the vacuum tank 102 is placed under a vacuum from an external vacuum pump, material may be drawn into the vacuum tank 102. Mounted on the vacuum tank 102 is a thermo relief valve 105. Fluidly attached to the vacuum tank 102 may be one or more openings for loading and unloading. Each opening may be closed to fluidly seal the vacuum tank 102. In this vacuum tank 102, a front pipe port 107 is shown.

Fluidly attached to the vacuum tank 102 may be one or more openings for loading and unloading. Each opening may be closed to fluidly seal the vacuum tank 102. In the disclosed vacuum tank 102 a front pipe port 107 may be utilized. The front pipe port 107 can be used either for loading or unloading depending on requirements dictated by the worksite at which the slurry box 101 is located. A vacuum pump may be fluidly attached to the front pipe port 107 or any other pipe port on the slurry box 101. The extent of the vacuum to be applied within the vacuum tank 102 may range from relative atmospheric pressure to a full vacuum depending on the application at a worksite. In the event the front pipe port 107 is not being utilized at a job site, the front pipe port 107 may be covered or may be connected to a valve which seals the opening. Any opening on the vacuum tank 102, including the front pipe port 107, may be jacketed with an exterior surface to allow a heat fluid flow to be circulated around an inner surface. In one example, the front pipe port 107 may have a five inch inner surface through which material may be loaded or unloaded to the vacuum tank 102 and a six inch exterior surface.

At the rear 109 of the slurry box 101 a tailgate 110 can be attached. The tailgate 110 is attached to hinges on the slurry box 101 which allow the tailgate 110 to be mechanically opened vertically. By attaching the tailgate 110 on the slurry box 101 such that it is vertically opened the slurry box 101 does not require additional lateral space to either side. In many applications, the slurry box 101 needs to be unloaded at sites which do not allow for excess lateral space around the slurry box 101. When closed, the tailgate 110 is sealed to the vacuum tank 102 such that the vacuum tank 102 may maintain vacuum pressure.

The structure 103 of the slurry box 101 is attached to the vacuum tank 102. The structure 103 may include a ladder to facilitate access to the manhole 104 at the top of the slurry box 101. The structure 103 allows for the slurry box 101 to be lifted, moved, or transported. At the bottom of the slurry box 101 a rear wheel set 112 is attached to the structure 103 near the rear 109. The rear wheel set 112 is as commonly appreciated for use in roll-off containers. In the exemplary embodiment shown in FIG. 1 an optional front wheel set 113 is also provided. The rear wheel set 112 and the optional front wheel set 113 as included in some embodiments comprise a base wheel set.

The structure 103 permits the slurry box 101 to be stacked vertically. Many gas or oil well sites have limited space on which equipment can be placed and the ability to stack the slurry box 101 is a valuable function. To enable the stacking function, attached to the structure 103 is at least one stacking leg 111 and at least one stacking mount 114. In an exemplary embodiment, four stacking mounts and four stacking legs are provided. A wheel platform 115 may be attached to the structure 103 to support a wheel set when a slurry box 101 is stacked. In this embodiment, a set of rear wheel platforms are demonstrated in a position that would support the rear wheel set 112 when stacked. The slurry box 101 may be lifted using d-rings and chains, a forklift, or any other lifting mechanism. When stacked each respective stacking leg 111 fits into each respective stacking mount 114. The one or more stacking mounts collectively form a stacking mount system. The one or more stacking legs form a stacking leg system. The stacking leg systems fits together with the stacking mount system.

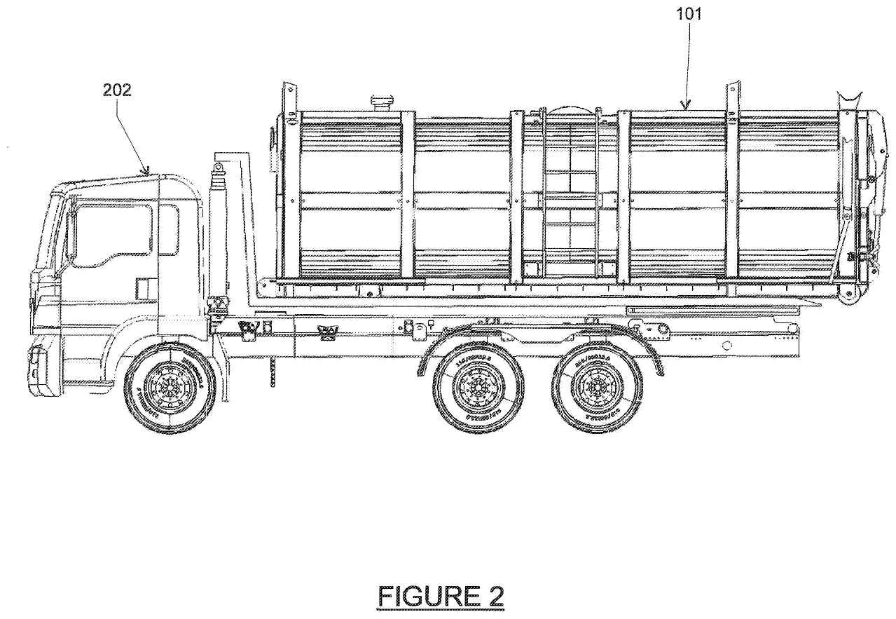

In the disclosed embodiment, the slurry box 101 is shown to be similar to a roll-off container. A roll-off container is a portable container which may be transported on a vehicle 202 (FIG. 2). The slurry box 101 may be, for example, a cable type roll-off container. A cable roll-off container may be pulled or placed on a vehicle such as a tilt-bed vehicle such as a truck or trailer by a winch.

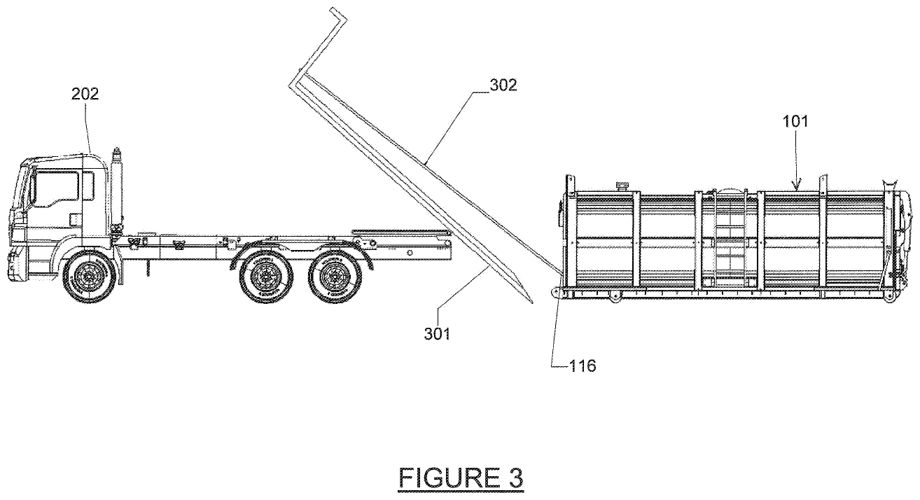

A cable 302 (FIG. 3) driven by the winch may be attached to a hook point 116 on the structure 103. The slurry box 101 may be then pulled onto the vehicle. In an alternative embodiment, the structure 103 may be built to allow for the hook point 116 to be attached near the top of the structure 103 to allow for a hook-loader type vehicle to pull the slurry box 101 onto the vehicle. For the purpose of this disclosure, a roll-off vehicle is considered to be either a tilt-bed vehicle, a truck trailer combination, or a hook-loader type vehicle. A truck trailer combination type vehicle is a vehicle 202 where a truck pulls a trailer, the trailer which is a hook-loader type trailer or a tilt-bed type trailer. In a truck trailer combination, the slurry box 101 is pulled onto the trailer section of the truck trailer combination just as a slurry box 101 is pulled onto a tilt-bed vehicle or a hook-loader type vehicle.

The slurry box 101 may be sized to fit on a vehicle. The slurry box 101 may be built in a variety of sizes and shapes to for different vehicles. An exemplary slurry box 101 may be 2.26 meters (89 inches) wide by 7.37 meters (290 inches) long. A slurry box 101 with such dimensions would be compliant with certain various jurisdictional transportation requirements.

A mechanical bay 106 may be located within the slurry box 101. In the mechanical bay 106 certain ancillary equipment is located such as an example power unit 801 for providing heat energy to fluid within warming tubes and jacketed openings. The power unit 801 is adapted to provide heat energy to fluid within the system of warming tubes and jacketed openings. The system of warming tubes and jacketed openings receive a heating fluid which is provided heat from the power unit by the use of a heat exchanger or other system. The fluid is circulated through the system of warming tubes and jacketed openings to distribute the heat energy. The fluid being circulated is a heated fluid flow. The power unit 801 may also provide energy to power a hydraulic pump to produce flow and pressure to operate various hydraulic functions. Such hydraulic functions include but are not limited to hydraulically opening the vertical tailgate. The power unit 801 may include a diesel engine with a fuel tank, an electric motor with a battery bank, or such. The power unit may also provide energy to power a hydraulic pump to produce flow and pressure to operate various hydraulic functions. Such hydraulic functions include but are not limited to hydraulically opening the tailgate 110. The mechanical bay 106 may be designed to allow for the power unit to be disconnected and removed when not needed. An exhaust port 118 is positioned to allow for gas and air to circulate out of the mechanical bay 106.

A thermo relief valve 105 may be provided such that if the pressure within the vacuum tank 102 increases, the pressure can be safely emitted from the tank. The thermo relief valve 105 ensures that the vacuum tank 102 does not obtain a positive pressure.

The slurry box 101 may be constructed of rigid materials, such as steel or aluminum. The structure 103 materials must be of requisite strength to allow for the slurry box 101 to be lifted, transported, and the vacuum tank 102 filed with materials. The vacuum tank 102 is constructed of materials capable of withstanding negative pressure up to a full vacuum.

FIG. 2 is a perspective view of the slurry box 101 mounted on an example vehicle 202. The vehicle 202 in this exemplary figure is a tilt-bed roll-off type vehicle. The exemplary slurry box 101 is shown as a cable type roll-off embodiment. Other types of vehicles and roll-off embodiments may be used as commonly appreciated by a person of ordinary skill in the art. The vehicle 202 configured as a tilt-bed roll-off type vehicle is capable of pulling the slurry box 101 onto the vehicle 202 and capable of causing the slurry box 101 to be displaced from the vehicle 202. The vehicle may cause a slurry box 101 to be displaced from the vehicle 202 and then pull a different slurry box 101 onto the vehicle 202. A well site may require multiple slurry boxes placed on site.

A roll-off container is a portable container that may be transported on a vehicle 202. In the figure, the slurry box 101 is shown similar to a cable-type roll-off container. A cable-type roll-off container may be pulled or placed on a vehicle such as a tilt-bed vehicle or trailer using a winch or hydraulic rams with cables (FIG. 3). The vehicle 202 in the exemplary figure shows a tilt-bed roll-off type vehicle. The vehicle 202 is shown with a tilt-bed 301 and a cable 302. The cable 302 can be used to pull the slurry box 101 onto the tilt-bed 301.

The cable 302 is attached to a winch and to a hook point 116 on the slurry box 101. The slurry box 101 may then be loaded 1050 onto the vehicle 202 utilizing pulling force from the winch. In an alternative embodiment, the slurry box 101 may be built to allow the hook point to be attached near the top of the slurry box 101 to allow for a hook-loader type vehicle to load the slurry box 101 onto the vehicle 202.

A roll-on-roll-off vehicle is considered to be either a tilt-bed vehicle, a truck-trailer combination, a hook-loader, or a cable type vehicle. A truck-trailer combination-type vehicle is a vehicle 202 where a truck pulls a trailer, the trailer which is a hook-loader type trailer or a tilt-bed type trailer. In a truck-trailer combination, the slurry box 101 is pulled onto the trailer section of the truck-trailer combination just as a slurry box 101 is pulled onto a tilt-bed vehicle or a hook-loader type vehicle. Alternatively, the vehicle 202 may be a sled configured to be transported in snowy and icy conditions. The sled is configured to handle both the weight and size of the slurry box 101 after being filled. Commonly, a sled configured to be used in snowy and icy conditions is pulled by a tracked vehicle.

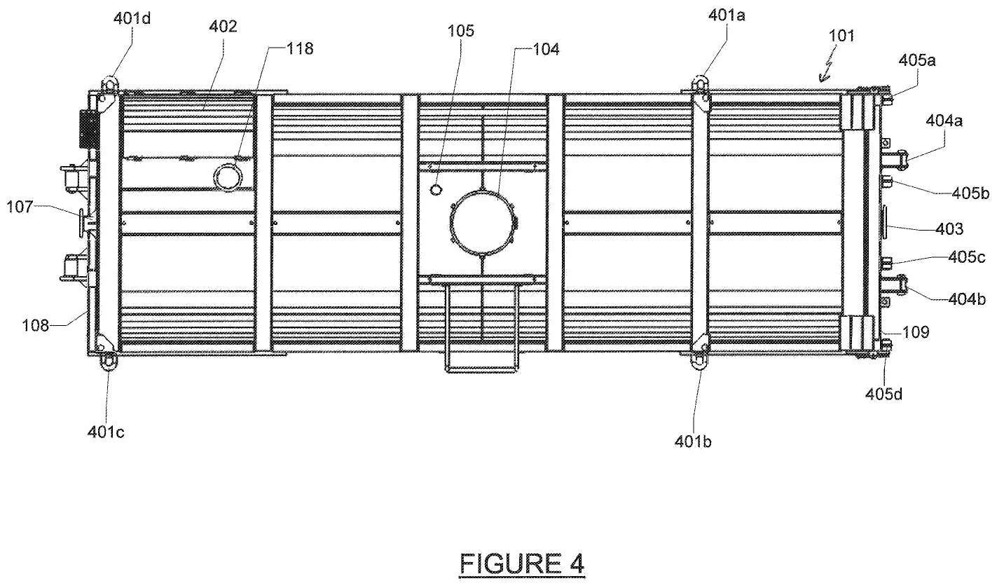

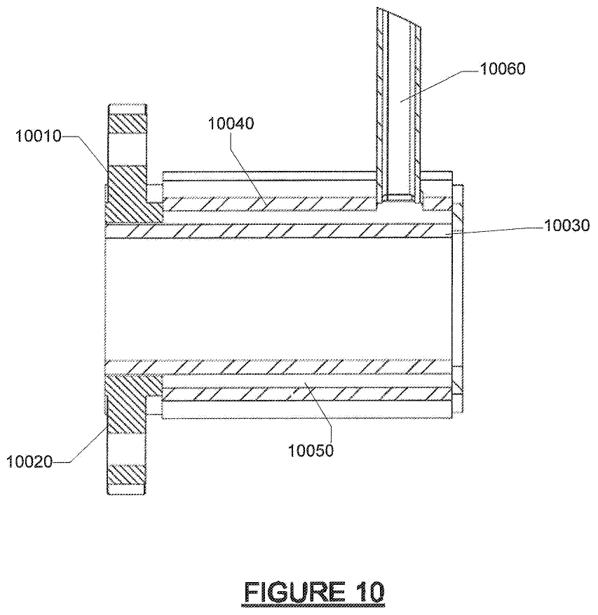

FIG. 4 is a view of the top of an exemplary slurry box 101. Shown on the top of the slurry box 101 is the manhole 104, the thermo relief valve 105, the exhaust port 118, as well as other slurry box 101 features. In this embodiment, a set of lift hooks 401 are shown attached to the structure 103. The lift hooks 401 are positioned to allow for the slurry box 101 to be picked up. Near the front 108 of the slurry box 101 the mechanical bay 106 is shown. Access to the mechanical bay 106 can be had via a bay cover 402. At the front 108 of the slurry box 101 a front pipe port 107 may be provided. At the rear 109 of the slurry box 101 a rear pipe port 403 may be provided. Like the front pipe port 107, the rear pipe port 403 may be jacketed (FIG. 10) to allow for a heated fluid flow to be circulated around the inner surface such to keep the material within the vacuum tank 102 and within the jacketed flange from freezing.

At the rear 109 of the slurry box 101 a hydraulic mount 404a, 404b is shown where a hydraulic cylinder may be connected. The hydraulic cylinder may be connected on the opposite end to the tailgate 110. When hydraulic pressure is delivered to the hydraulic cylinder, the tailgate 110 may be opened or closed by the retracting or extending of the hydraulic cylinder. The tailgate 110 is attached to the slurry box 101 with at least one tailgate hinge 405. In this embodiment, four hinges are shown.

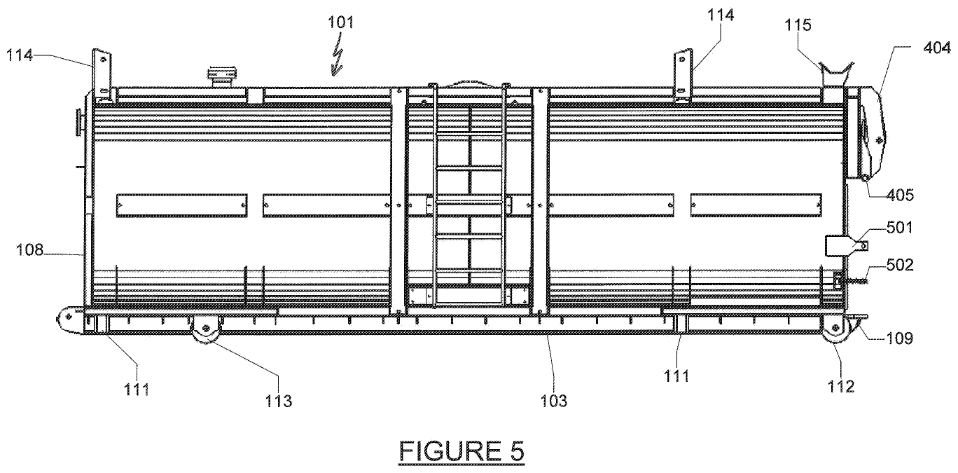

FIG. 5 is a view of the driver-side perspective of an exemplary slurry box 101. Shown attached to the structure 103 is the front wheel set 113 and a rear wheel set 112. A stacking leg 111 is attached near the front 108 of the slurry box 101 and near the rear 109. A stacking mount 114 is attached near the front 108 of the slurry box 101 and near the rear 109. A rear wheel platform 115 is shown near the rear 109 of the slurry box 101.

At the rear 109 of the slurry box 101, a hydraulic mount 404 is shown. In FIG. 5 the tailgate 110 and hydraulic cylinders are removed from the drawing. At least one tailgate hinge 405 is shown. A latch receiver 501 is attached to the vacuum tank 102. The latch receiver 501 interfaces with the tailgate 110 such that when the tailgate 110 is in the closed position, a hydraulic latch mounted on the tailgate 110 secures into the latch receiver 501. When the hydraulic latch is secured into the latch receiver 501, the tailgate 110 may not be moved from the closed position. The closed position is when the tailgate 110 is secured to the vacuum tank 102 and a fluid seal is made between the vacuum tank 102 and the tailgate 110. A manual latch 502 is attached to the vacuum tank 102. The manual latch 502 in this exemplary embodiment comprises a threaded bolt and a wingnut secured on the threaded bolt when the tailgate 110 is in the closed position. The wingnut in the example, is to be removed by an operator.

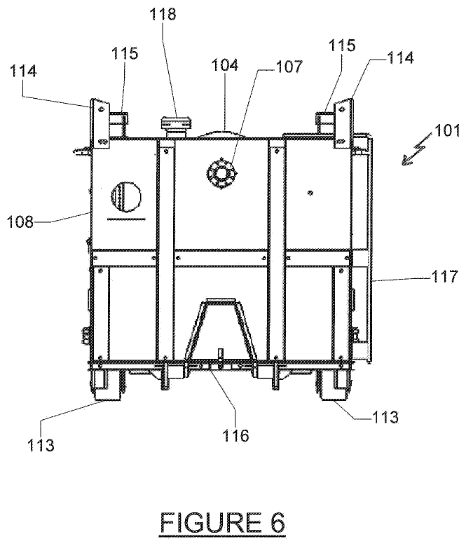

FIG. 6 is a front view of the front 108 of the slurry box 101. Shown in the figure is the front pipe port 107 near the top of the slurry box 101. Mounted near the top of the slurry box 101 is a least one stacking mount 114. In the figure, two stacking mounts are displayed. At the bottom of the slurry box 101 at least one front wheel set 113 is shown. In the exemplary figure, two wheels are shown. A hook point 116 is shown in the figure. Shown in the figure is a partial view of a set of rear wheel platforms, a partial view of the manhole 104, and the exhaust port 118. On the side of the slurry box 101 can be seen a side profile of the ladder 117.

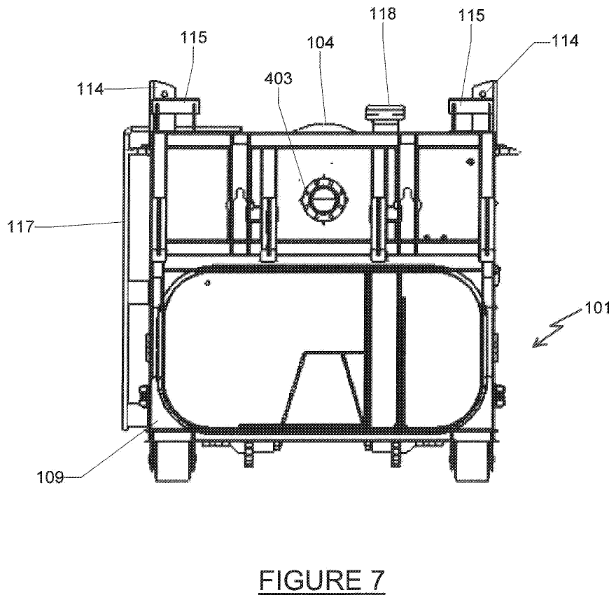

FIG. 7 is a view of the rear 109 of the slurry box 101. Attached to the slurry box 101 is at least one rear wheel platform 115. Shown in this embodiment is two rear wheel platforms. Alternatively, the slurry box 101 may be configured without any rear wheel platforms. At least one stacking mount 114 is attached to the slurry box 101. In the figure two stacking mounts are displayed. On the side of the slurry box 101 can be seen a side profile of the ladder 117. The manhole 104 and the exhaust port 118 may be located at the top of the slurry box. The manhole 104, the ladder 117, and the exhaust port 118 are not essential in all embodiments of the invention disclosed in this description. An optional rear pipe port 403 is shown.

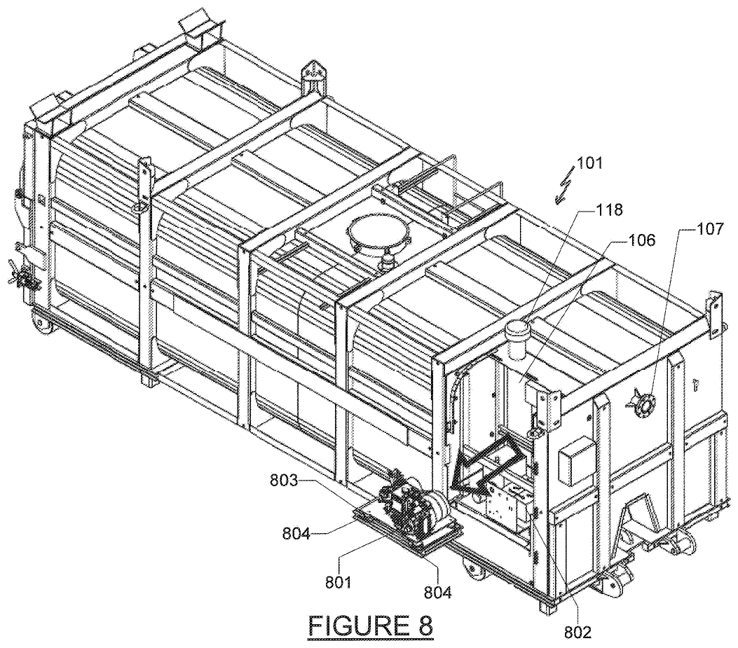

FIG. 8 is an exemplary slurry box 101 and shows how the power unit 801 can be removed. The slurry box 101 is shown with a bay cover 402 opened such to allow access to the mechanical bay 106. The exhaust port 118 allows for exhaust to be vented from the mechanical bay 106. In the exemplary figure a diesel engine is shown as the power unit 801. The power unit 801 is connected to a hydraulic pump to produce hydraulic pressure, connected to a pump to provide a fluid flow through the warming tubes, and configured to provide heat energy to the fluid within the warming tubes. The diesel engine may be substituted with an alternative power unit device. Such alternatives include but are not limited to an electric motor, a gasoline engine, a turbine, or any other such device appreciated by one with ordinary skill in the art. The power unit 801 uses an energy source 802 attached to the slurry box 101. The energy source 802 may be electrical energy, chemical energy, gasoline, diesel, or other such energy source 802 which is compliant with the relevant power unit 801.

The power unit 801 may be configured on a skid 803 which allows for the power unit 801 to be removed from the mechanical bay 106. The skid 803 may be configured with one or more forklift pockets 804 to allow for the skid 803 and items to which it is attached to be removed from the mechanical bay 106 using a forklift. In alternative embodiments, the hydraulic pump and/or other components may be attached to the skid 803 to allow for removal from the mechanical bay 106. Any type of quick disconnect connectors understood by a person of ordinary skill in the art may be used to connect the skid 803 and items to which it is attached to warming tubes, hydraulic lines, electrical connections, and other elements on the slurry box 101.

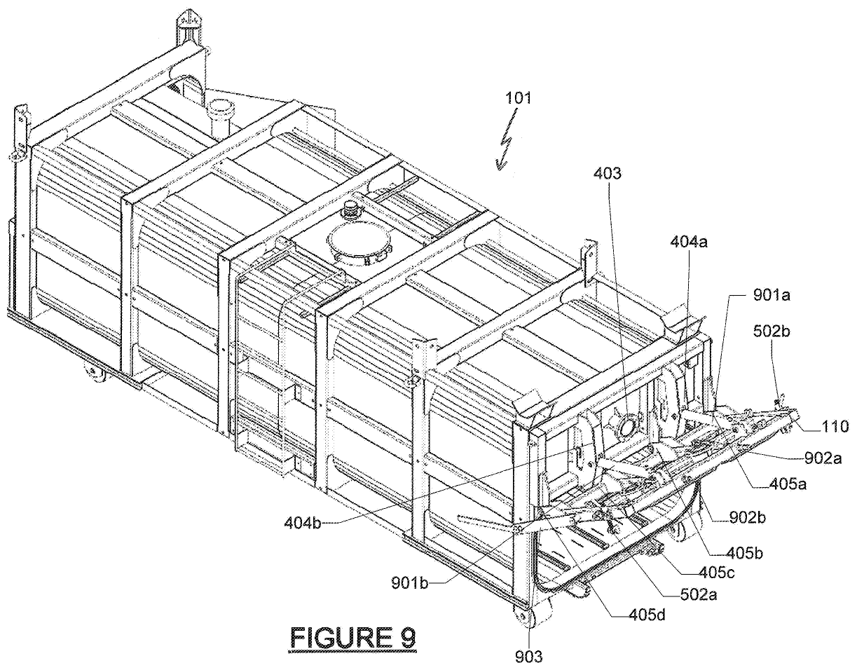

FIG. 9 is a perspective of the slurry box 101 showing the tailgate 110 in the open position. The tailgate 110 may be opened using hydraulic force or any other force. In some embodiments, at least one hydraulic cylinder 901 is used to open and close the tailgate 110. In the figure, two hydraulic cylinders are connected between the tailgate 110 and each hydraulic mount 404. The tailgate 110 is attached to the vacuum tank 102 by at least one tailgate hinge 405. The one or more hinges may be attached to the structure 103 or may be attached to the vacuum tank 102. The tailgate 110 closes such that it is attached to the vacuum tank 102 and fluidly seals the vacuum tank 102 when it is closed. In the exemplary embodiment a set of four hinges are shown which comprise the hinge 405. The tailgate hinge 405 is configured such that its axis is parallel to the bottom of the structure 103. The tailgate 110 pivots on the tailgate hinge 405 such that it opens vertically.

When the tailgate 110 is moved to the closed position such that the tailgate 110 fluidly seals the vacuum tank 102, the tailgate is secured against the vacuum tank 102. The tailgate 110 can be secured against the vacuum tank 102 using a latch receiver 501, manual latch 502 as shown in FIG. 5, as shown in FIG. 9, or any other method appreciated by a person with ordinary skill in the art. In FIG. 9 an alternative type of manual latch 502 is shown. A vertical latch 902 may be used to secure the tailgate 110. The vertical latch 902 in this embodiment is functioned by a hydraulic force. A safety brace 903 may be attached to the structure 103 to ensure the tailgate 110 is forcefully maintained in an open position such that the tailgate 110 may not close due to the force of gravity or due to hydraulic force from a hydraulic cylinder 901. The safety brace 903 is hingedly attached to the structure 103 or vacuum tank 102 and is configured such that the tailgate 110 may not close when the safety brace 903 is positioned against the tailgate 110.

The vertical tailgate may be opened using hydraulic force or any other force. In some embodiments, at least one hydraulic cylinder is used to open and close the vertical tailgate. The vertical tailgate is attached to the vacuum tank 102 by at least one tailgate hinge. The one or more hinges may be attached to the structure 103 or may be attached to the vacuum tank 102. The vertical tailgate closes so as to fluidly seal the vacuum tank 102. In the exemplary embodiment a set of four hinges may be used which comprise the hinge. The tailgate hinge is configured such that its axis is parallel to the bottom of the structure. The vertical tailgate pivots on the tailgate hinge such that it opens vertically.

A mechanical bay 806 may be located within the slurry box 101. In the mechanical bay 806, certain ancillary equipment is located. A power unit for providing heat energy to fluid within a system of warming tubes and jacketed openings is located in the mechanical bay 806. The power unit may also provide energy to power a hydraulic pump to produce flow and pressure to operate various hydraulic functions. Such hydraulic functions include but are not limited to hydraulicly opening the vertical tailgate. The power unit may be a diesel engine with a fuel tank, an electric motor with a battery bank, or any other method as appreciated by one with ordinary skill in the art. The mechanical bay 806 may be designed to allow for the power unit to be disconnected and removed when not needed. An exhaust port 818 is positioned to allow for gas and air to circulate out of the mechanical bay 806.

A slurry box 101 in other embodiments also comprises a vertical tailgate which allows for the slurry box 101 to be unloaded in a compact space and the capability to heat the contents of the slurry box 101 to a temperature above freezing. The heating capability may be by the circulation of a heated flow of liquid through the system of warming tubes distributed through the slurry box 101. The system of warming tubes are configured with a particular design that doesn't impede the payload to slide out. Multiple slurry boxes may be stacked to conserve room on a well site. Multiple slurry boxes as disclosed herein may be stored at an oil rig site to allow the oil rig to continue operating during inclement weather. For example, there may be a second slurry box and a third slurry box to form a slurry box stack.

FIG. 10 is a view of an exemplary jacketed flange 10010. The exemplary jacketed flange 10010 may be utilized with the front pipe port 107, the rear pipe port 403, or any other port in the vacuum tank 102. The jacket flange 10010 comprises of a flange face 10020, an inner surface 10030, an exterior surface 10040, and a warming channel 10050. Attached to the jacketed flange 10010 is a warming tube 10060. The warming tube 10060 conveys the heated fluid flow to the jacket flange 10010 warming channel 10050. The heated fluid flow is fluid which was heated by the power unit 801. The warming tube 10060 may be connected from any angle or location. The heated fluid flow which is conveyed to the warming channel 10050 maintains a temperature which causes any material located within the area contained by the inner surface 10030 to remain above a freeze temperature. The inner surface 10030 is essentially an opening which allows material to flow through. The exterior surface 10040 encloses the inner surface 10030.

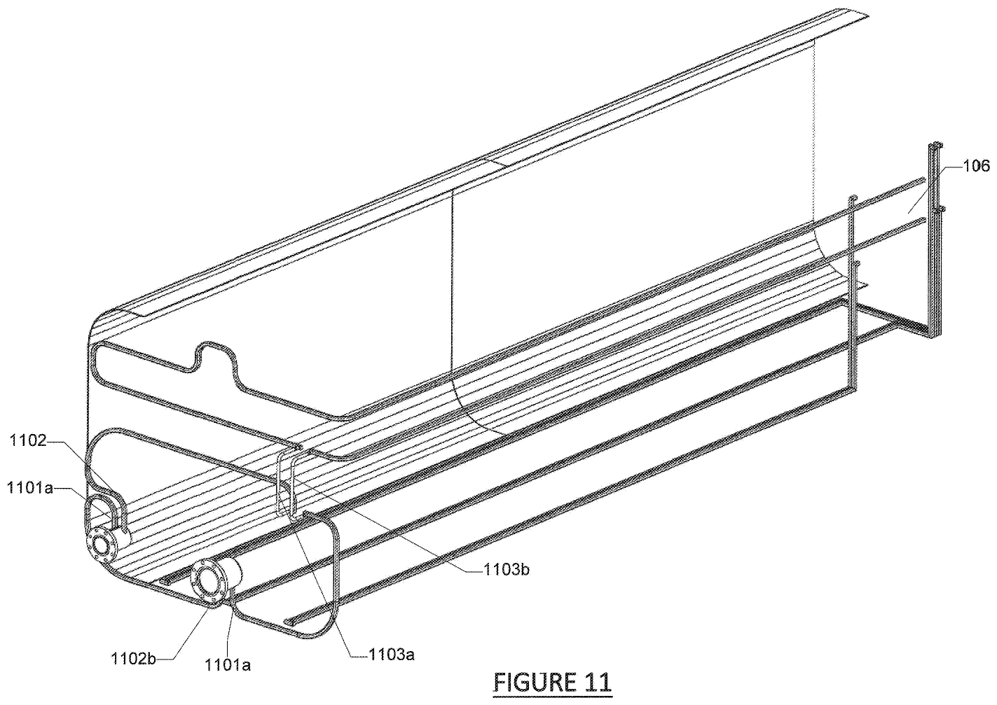

FIG. 11 is a view of an exemplary set of warming tubes. The figure does not include all potential warming tubes which may be attached to the vacuum tank 102. Shown are two jacketed flanges which represent the location at which the tailgate 110 would be positioned when closed. The two shown flanges would be attached to the tailgate 110. A supply warming tube 1101 and an exit warming tube 1102 is attached to each of the jacketed flanges. Hinge warming tubes 1103 are used to connect warming tubes in the tailgate 110 to warming tubes attached to the vacuum tank 102. Warming tubes are configured to be positioned such to connect to connectors in the mechanical bay 106.

The slurry box 101 is such that it can be placed on a vehicle 202 for transportation or moved at a particular location. For example, the vehicle 202 can be a self-loading vehicle which can pull the slurry box 101 onto the vehicle 202. An example of a vehicle hat can be used with the slurry box 101 is that which is traditionally understood as a roll-off truck. With this, the slurry box 101 can be loaded or unloaded from a vehicle 202. The slurry box 101 includes at least a vacuum tank 102 that can hold a vacuum when a vacuum pump is fluidly connected to the vacuum tank. The vacuum can cause material such as drilling cuttings to be drawn into the vacuum tank.

The mechanical bay 806 may be located within the slurry box 101. In the mechanical bay 806, certain ancillary equipment is located. A power unit for providing heat energy to fluid within a system of warming tubes and jacketed openings is located in the mechanical bay 806. The power unit may also provide energy to power a hydraulic pump to produce flow and pressure to operate various hydraulic functions. Such hydraulic functions include but are not limited to hydraulicly opening the vertical tailgate. The power unit may be a diesel engine with a fuel tank, an electric motor with a battery bank, or any other method as appreciated by one with ordinary skill in the art. The mechanical bay 806 may be designed to allow for the power unit to be disconnected and removed when not needed. An exhaust port 818 is positioned to allow for gas and air to circulate out of the mechanical bay 806.

In summer months, the heating function of the slurry box 101 may not be needed. In summer months, frozen roads during winter may have thawed and become rough, causing additional wear and tear on equipment being transported thereon.

The vertical tailgate allows for the slurry box 101 to be unloaded in a compact space and the capability to heat the contents of the slurry box 101 to a temperature above freezing. The heating capability may be by the circulation of a heated flow of liquid through the system of warming tubes distributed through the slurry box 101. The system of warming tubes is configured with a particular design that doesn't impede the payload to slide out. Multiple slurry boxes may be stacked to conserve room on a well site. Multiple slurry boxes as disclosed herein may be stored at an oil rig site to allow the oil rig to continue operating during inclement weather. For example, there may be a second slurry box and a third slurry box.

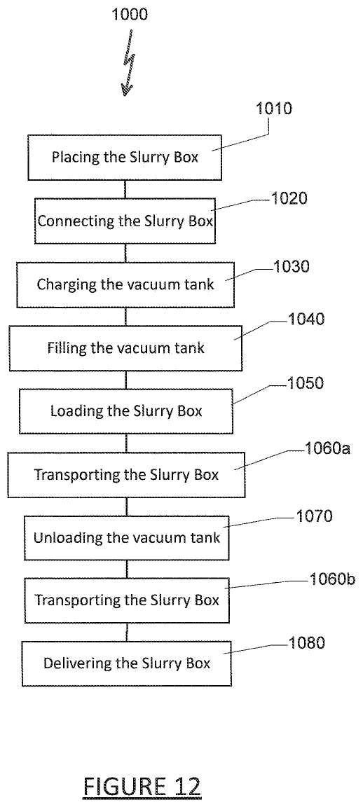

FIG. 12 is a simplified block diagram showing a method in which a slurry box 101 is used efficiently according to one disclosed non-limiting embodiment. The disclosed method 1000 generally includes placing 1010 the slurry box 101 so it can be connected to an oil rig; connecting 1020 the slurry box 101; charging 1030 the vacuum tank 102; filling 1040 the vacuum tank; loading 1050 the slurry box 101 onto the vehicle 202; transporting 1060a the slurry box 101 to a disposal facility; unloading 1070 the vacuum tank; transporting 1060b the slurry box 101 to an oil rig site; and delivering 1080 the slurry box 101 at an oil rig site. For the purpose of this application, an oil rig site refers to a drill site which may be either an oil or gas rig site. For this application, an oil rig refers to either an oil or gas rig.

The steps as described and shown need not start with placing 1010 the slurry box 101; rather, the disclosed method can start and end at any step within the disclosed process. For example, the disclosed method may start with transporting 1060b the slurry box 101 to an oil rig site and end with unloading 1070 the slurry box 101 at a disposal facility.

The step of placing 1010 a slurry box 101 at an oil rig site includes the act of moving the slurry box 101 to a location near the oil rig such that the slurry box 101 may be connected to a vacuum source, and the inlet of the slurry box 101 is connected to the slurry cutting outlet attached to the oil rig. The oil rig operator typically designates the location at which the slurry box 101 is placed. The location at which the slurry box 101 is placed may be different from where the slurry box 101 is delivered 1080 to the oil rig site. The slurry box 101 may be moved from a storage location designated at the oil rig site to where the slurry box is to be placed 1010. Slurry boxes may be stacked vertically at the oil rig site for storage purposes. The slurry box 101 may be removed from a stack and then placed 1010.

Alternatively, a vehicle 202 may deliver 1080 a slurry box 101 to an oil rig site in a way that the vehicle 202 places 1010 the slurry box 101. The vehicle 202 may have the capability to self-load and self-unload. When a vehicle 202 which is delivering 1080 the slurry box 101 places 1010 the slurry box 101, the slurry box 101 is not being moved from a storage location on the oil rig site. Rather it is being placed 1010 directly from the vehicle 202.

The step of connecting 1020 the slurry box 101 includes may include configuring the inlet of the vacuum tank 102 to be fluidly attached to the slurry cutting outlet attached to the oil rig, and fluidly attaching the vacuum port to a vacuum source. When a slurry box 101 is properly placed 1010 at an oil rig site, the connecting 1020 step can occur.

An inlet on the slurry box 101 is an opening in the vacuum tank 102 through which slurry cuttings can flow into the vacuum tank 102 from a pipe or hose. The inlet is configured such that it can fluidly seal to the slurry cutting outlet of the oil rig. Typically, the inlet may include a flanged pipe or quick connect hose. However, when not fluidly attached to the outlet, the inlet may be fluidly sealed to not allow debris to enter the vacuum tank.

A vacuum port on the slurry box 101 is an opening in the vacuum tank 102 through which a vacuum source may charge 1030 the vacuum tank 102 with a vacuum. The vacuum port is configured such that it can fluidly seal to a vacuum source. Typically, the vacuum port will include a flanged pipe or quick connect hose such as pipe port 107 or pipe port 403. However, when not fluidly attached to the vacuum source, the vacuum port may be fluidly sealed such to not allow debris to enter the vacuum tank.

The vacuum source may be provided by a vacuum pump located at the oil rig site. The vacuum pump is sized accordingly such that it can remove air from the vacuum tank 102 such that the vacuum tank 102 becomes under vacuum pressure. The vacuum pump can be a stand-alone unit designated for use with slurry boxes, or can be a vacuum pump used for purposes beyond the slurry box 101. The vacuum pump can be driven by electric energy, an internal combustion engine, a diesel engine, or any other power source.

Drill cuttings are produced during drilling of oil wells and gas wells. The drill cuttings are carried to the surface by a drilling fluid circulating up from the drill bit. The drill cuttings are separated from the drilling fluid so the recycled drilling fluid may be reused during the drilling process. The separated drill cuttings and a portion of the drilling fluid and other liquids form slurry cuttings that must be removed from the oil rig site. Slurry cuttings are expressed from the oil rig through an outlet. The outlet may be pumped from the oil rig itself, mud pits, or a holding tank. In the disclosed process herein, the outlet must be configured to fluidly attach to the inlet of the slurry box 101.

The step of charging 1030 the slurry box 101 includes pulling a vacuum on the vacuum tank. Once the slurry box 101 is connected 1020, the vacuum tank 102 is fluidly sealed from the atmosphere and the only external connections attached to the vacuum tank 102 are through the inlet and vacuum port. When the vacuum tank 102 is sealed from the atmosphere, a vacuum can be charged 1030 to the tank. For the sake of this application, charging a vacuum is understood to be the act of removing air from the vacuum tank 102 and therefore creating a negative pressure within the vacuum tank. Vacuum Pressure is the state in which the vacuum tank 102 is in when in a vacuum. When at vacuum pressure, the vacuum tank 102 is charged to a pressure that is less than atmospheric pressure and less than the pressure in the slurry cutting outlet, such that slurry cuttings may be filled 1040 into the slurry box 101. The vacuum can range from slightly below atmospheric pressure to a full vacuum, depending on how quickly the oil rig operator wishes the slurry cuttings to flow into the vacuum tank. The vacuum pump can be configured to continue to charge 1030 vacuum pressure into the vacuum tank 102 until the vacuum tank 102 is filled with slurry cuttings to such a level as desired by the oil rig operator or transport operator.

The step of filling 1040 the vacuum tank 102 is to allow slurry cuttings to be pulled into the vacuum tank 102 by the force of the vacuum pressure charged 1030 into the vacuum tank. As slurry cuttings are pulled into the vacuum tank, the vacuum pump can continue to charge 1030 the vacuum tank 102 until the desired level of slurry cuttings is filled into the vacuum tank. An exterior fill level gauge may be configured on the slurry box 101. By watching the exterior level gauge, the operator may visually monitor the amount of slurry cuttings filling the slurry box 101 so to ensure the slurry box 101 is not overfilled beyond the intended amount per load.

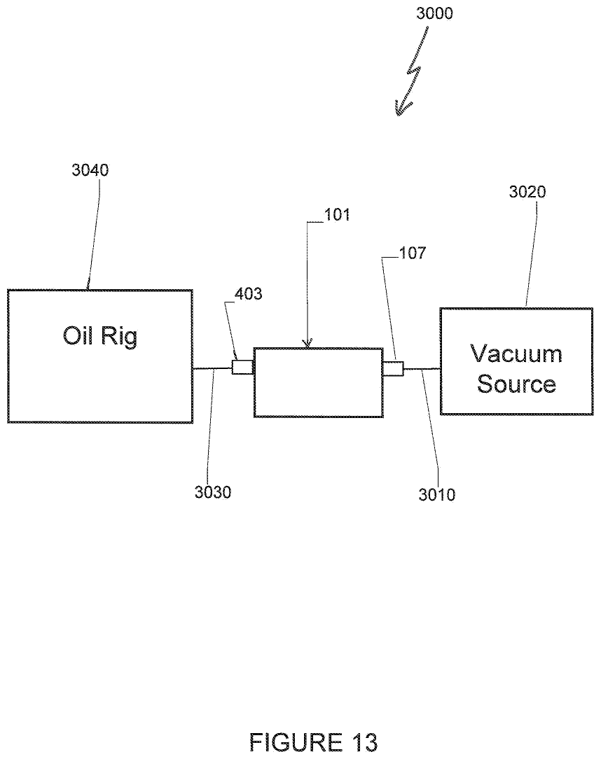

Once the vacuum tank 102 on the slurry box 101 is filled 1040 to the desired level, the slurry box 101 may be disconnected from the oil rig slurry cuttings output and disconnected from the vacuum source (FIG. 13). The slurry box 101 may then be moved to another location at the oil rig site or directly loaded 1050 onto a vehicle 202. Moving the slurry box 101 to another location at the oil rig site allows for a different slurry box 101 to be placed 1010 to connect 1020. Slurry boxes that are moved to another location at the oil rig site are placed in a location for storage. While in storage, the oil rig operator can choose to stack multiple slurry boxes vertically.

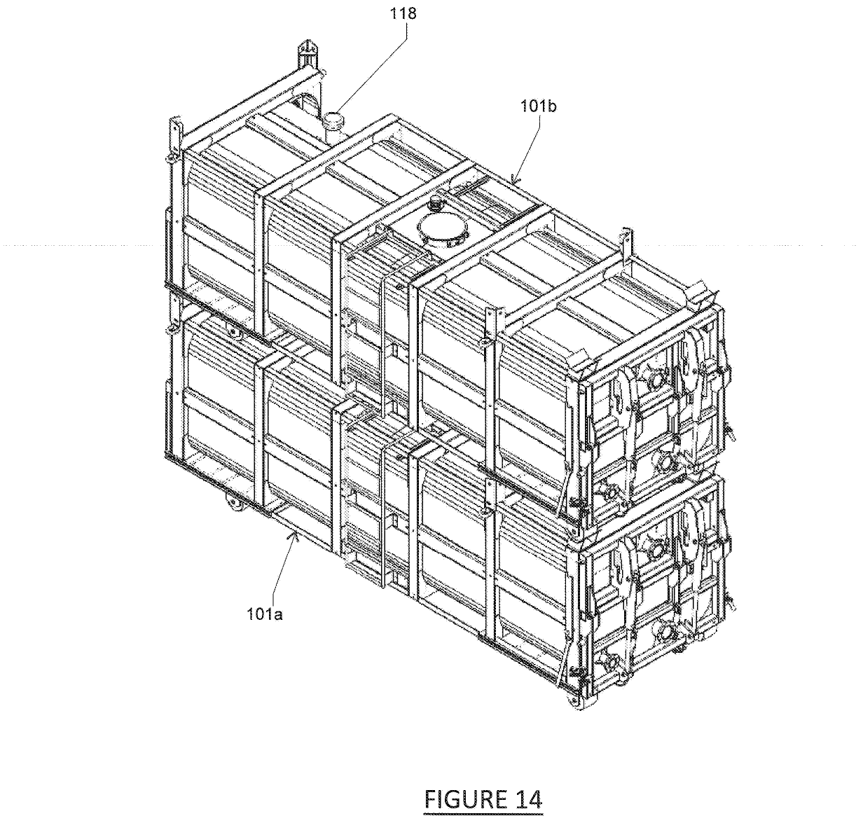

Stacking slurry boxes 101a, 101b (FIG. 14). reduces the land area needed at an oil rig site. The slurry box 101 may be stacked vertically when more than one slurry box 101 is used. Many gas or oil rig sites have limited space on which equipment can be placed and the ability to stack the slurry boxes is a valuable function. The slurry box 101 may be lifted using d-rings, slings cables, or chains, a forklift, or any other lifting mechanism. The slurry box 101 need only be moved into a storage location for a temporal period and will eventually be loaded 1050 onto a vehicle 202.

Loading 1050 a slurry box 101 onto a vehicle 202 may include lifting the slurry box 101 onto a vehicle 202. The slurry box 101 may be loaded 1050 onto a vehicle 202 by force exerted from a pulling object. For example, a roll-off type vehicle could use a winch, a hydraulic ram, or a hook arm to pull the slurry box 101 onto the vehicle 202. Alternatively, the slurry box 101 may be loaded 1050 onto a vehicle 202 by lifting the slurry box 101 with an external device. For example, a forklift or a crane could pick up the slurry box 101 and load it onto the vehicle 202.

Transporting 1060a the slurry box 101 to a disposal facility includes physically moving the slurry box 101, which has been loaded 1050 on the vehicle 202 from the oil rig site to the disposal facility where it will be unloaded 1070. The slurry box 101 is transported 1060 on the vehicle 202 at two times in the disclosed method of use. The function of transporting 1060a the slurry box 101 to the disposal facility and transporting 1060b the slurry box 101 to the oil rig site essentially comprise the same functions and are both considered transporting 1060. Transporting includes moving the slurry box 101 between the disposal facility and the oil rig site.

Transporting 1060 the slurry box 101 can be performed by a vehicle 202 which is motorized, or can be performed by pulling the vehicle 202 with another device. The transporting 1060 function can be performed over a wide geographic region or may be a relatively short distance. The transporting 1060 may also include one or more transitions wherein the slurry box 101 is loaded 1050 on the vehicle 202 is removed from the vehicle 202 and placed on another alternative vehicle 202. For example, the slurry box 101 might be loaded 1050 on a vehicle 202 at the oil rig site which is of a sled embodiment. Once the slurry box 101 is transported 1060 a certain distance, the slurry box 101 may be transitioned onto the vehicle 202 of a roll-off embodiment. At this point, the slurry box 101 continues to be transported 1060 to the disposal facility. During the transporting 1060, the slurry box 101 may be transitioned multiple times. Different vehicles may be used for different portions of the transporting steps. For example, a sled may be used for at least a portion of the transporting.

Unloading 1070 the slurry box 101 includes emptying the slurry cuttings from the vacuum tank 102 within the slurry box 101. Once the slurry box 101 has been transported 1060a to the disposal facility, the slurry box 101 is positioned at a location at the disposal facility wherein the slurry box 101 is to be unloaded 1070. Multiple methods can be employed to unload 1070 the vacuum tank 102 within the slurry box 101. Methods to unload 1070 include but are not limited to dumping, using vacuum force, or scooping the cuttings slurry from the vacuum tank.

Transporting 1060b the slurry box 101 to an oil rig site includes physically moving the slurry box 101 on a vehicle 202 from the disposal facility to the oil rig site.

Delivering 1080 the slurry box 101 to the oil rig site is to remove the slurry box 101 from the vehicle 202 upon which the slurry box 101 was transported 1060. The slurry box 101 may be delivered 1080 at a location at the oil rig site used for storage or may be delivered 1080 to the location at the oil rig site wherein the slurry box 101 will be placed 101. If the slurry box 101 is delivered at a location used for storage, the slurry box 101 may be stacked.

FIG. 13 is a schematic view of an exemplary slurry box 101 at an example oil rig site 3000. A pipe 3010 is utilized to connect the vacuum port 107 to a vacuum source 3020. Another pipe 3030 or hose may be connected from the port 403 to the oil rig 3040 such the slurry cuttings may be communicated into the slurry box 101.

FIG. 14 is a perspective of two slurry boxes stacked on top of each other. Shown in the figure is a bottom slurry box 101a and an upper slurry box 101b. The slurry boxes are stacked on top of each other to save space. More than two slurry boxes may be stacked.

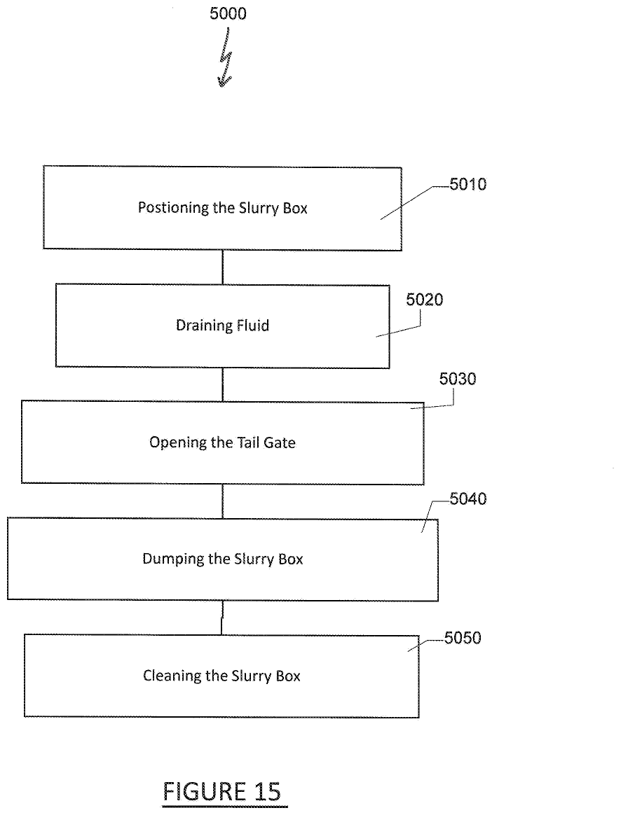

FIG. 15 is a simplified block diagram showing a method in which a slurry box 101 is unloaded 5000. The disclosed method comprises positioning 5010 the slurry box 101 at a location at the disposal facility; draining 5020 fluid from the slurry box 101; opening 5030 the tailgate on the slurry box 101; dumping 5040 the slurry box 101; and cleaning 5050 the slurry box 101. The slurry box 101 may be placed where it is stored, transported 1060 to an oil rig site, or used for other purposes.

Positioning 5010 the slurry box 101 at a disposal facility location is moving the slurry box 101 to the place where the slurry box 101 may be emptied of slurry cuttings. Often the disposal facility is constructed such that the slurry box 101 must be positioned 5010 in a location that does not allow for excess space horizontally around the vehicle 202 and slurry box 101. This effectively means that a slurry box 101 will not have excess room to open a tailgate horizontally; rather the slurry box 101 is better suited to be opened vertically.

Draining 5020 the slurry box 101 includes emptying the slurry box 101 of unconstrained fluid. The unconstrained fluid may be free-standing on the surface of the slurry cuttings or may be within the slurry cuttings. Draining 5020 the slurry box 101 includes opening a port in the vacuum tank 102 and tilting the slurry box such that the fluid flows through the port out of the vacuum tank. The port used to drain the fluid may be the inlet of the slurry box 101 used for filling 1040 the vacuum tank.

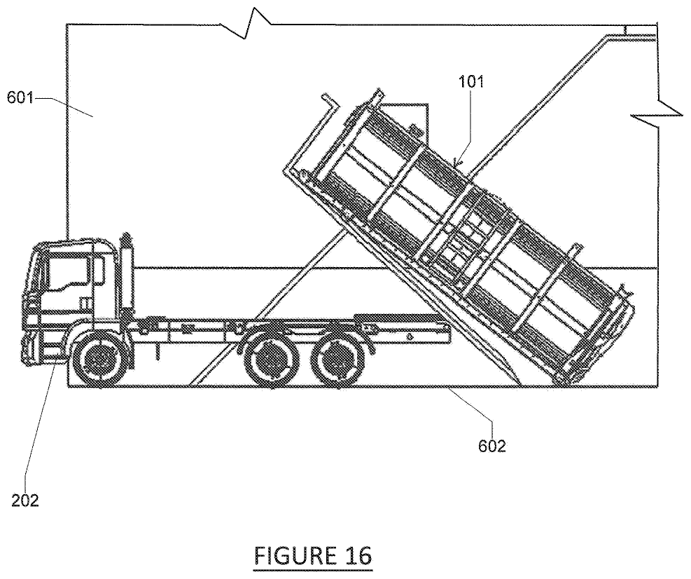

An elbow, hose, or other fitting may be attached to the opening, such as the inlet to direct the fluid as it is emptied from the vacuum tank. A valve may be used to control the flow of fluid and cuttings slurry from the vacuum tank. When the slurry box 101 is on a roll-off vehicle, the slurry box 101 may undergo the step of sliding back toward the rear of the vehicle 202 to accommodate for draining 5020 and dumping 5040. In such roll-off vehicle applications, the slurry box 101 is typically slid approximately 2.4 meters (8 feet) toward the rear of the vehicle 202. To facilitate the draining 5020 (FIG. 16), the vehicle 202 may be configured to raise the slurry box 101 such that one end of the slurry box 101 is higher than the end which is opened to empty fluid from the vacuum tank. The raising of the slurry box 101 is essentially the same function as commonly used by dump trucks. Raising one end of the slurry box 101 is considered tilting the slurry box 101. Once the requisite amount of unconstrained fluid is emptied from the vacuum tank, as determined by the vehicle 202 operator, the slurry box 101 may be lowered back to a horizontal position.

Opening 5030 the slurry box 101 includes causing the tailgate to be opened. At the rear of the slurry box 101 the tailgate is attached to hinges allowing the tailgate to be mechanically opened vertically with respect to a bottom of the slurry box 101. Attaching the tailgate on the slurry box 101 so that it is vertically opened ensures that the slurry box 101 does not need additional lateral space on either side. In many applications, the slurry box 101 needs to be unloaded at sites that do not allow for excess horizontal space around the slurry box 101. When closed, the tailgate is sealed to the vacuum tank 102 such that the vacuum tank 102 may maintain vacuum pressure.

The tailgate may be opened using hydraulic force or any other force. In some embodiments, at least one hydraulic cylinder is used to open and close the tailgate. The tailgate is attached to the slurry box 101 by at least one hinge. The tailgate closes to be secured to the vacuum tank 102 and fluidly seals the vacuum tank 102 when it is closed.

The tailgate can be secured against the vacuum tank 102 by force or may use one or more latches. The latches may be manually or mechanically operated. In addition, a safety brace may be attached to the slurry box 101 to ensure the tailgate is forcefully maintained in an open position such that the tailgate may not close due to the force of gravity or due to hydraulic force. The safety brace allows compliance with safety regulations and provides for safety concerns due to a closing tailgate.

Opening 5030 the tailgate may include unlatching any latches, applying force to cause the tailgate to move to an open position, and applying the safety brace when configured. The open position is typically such that the tailgate is at a 120-degree position relative to the position when fluidly sealed against the vacuum tank. A control such as a handheld remote may be used to cause the tailgate to move to an open position.

Dumping 5040 the slurry box 101 may include raising the slurry box to cause the slurry cuttings to empty from the vacuum tank. The step of dumping 5040 the slurry box 101 may include raising the slurry box 101 as previously describe in the draining 50200 step. The dumping 5040 may proceed once the tailgate has been opened 5030. In the dumping 5040, typically both drill cuttings and fluids forming the slurry cuttings are emptied from the vacuum box.

Draining 5020 the unconstrained fluid prior to dumping 5040 the slurry box 101 is to control the mass emptied from the vacuum tank. If the vacuum tank 102 was emptied of all slurry cuttings by skipping to the dumping 5040 step, the mass of slurry cuttings emptied out of the vacuum tank 102 would be uncontrolled. The mass would be uncontrolled because the slurry cuttings are comprised of solid drill cuttings and fluids. The slurry cuttings is a mix of solid and liquid such that it is in akin to a mud. Dumping such a load of material results in an uncontrolled dump and will result in a mess.

Once the dumping 5040 has been completed, the cleaning 5050 step may commence. The step of cleaning 5050 the slurry box 101 is generally comprised of using pressurized fluid to spray remaining slurry cuttings from the vacuum tank 102 and washing debris from seals on the vacuum tank. After the slurry box 101 is drained 5020 and dumped 5040, some slurry cutting will likely remain in the vacuum tank 102 due to adhesion to various surfaces. Pressurize fluid may be used to ensure the remaining slurry cuttings are emptied out of the vacuum tank. The fluid need not be under high pressure, rather any amount of pressure sufficient to spray fluid is required. For example, a garden hose spraying water at 50 PSI may be a sufficient spraying source.

Cleaning 5050 includes washing debris from seals on the vacuum tank. Specifically, a seal that causes the tailgate to be fluidly sealed to the vacuum tank 102 should undergo washing to ensure the tailgate can continue to seal between the tailgate and the vacuum tank. The seal is compressed between the vacuum tank 102 and the tailgate. The washing of the seals may simply include using the pressurized water to spray debris from the seal, or may include the act of scrubbing debris from the seals.

FIG. 16 is a perspective of the slurry box 101 tilted by a vehicle 202. next to a building 601. The vehicle 202, in this embodiment, is a roll-off vehicle. The vehicle 202 has tilted the slurry box 101 to a raised position. For the purpose of dumping 5040 (FIG. 15), the slurry box 101 may be held above the ground surface 602 or be permitted to touch the ground surface 602 as shown. The slurry box 101 need not touch the ground surface 602 while in the raised position.

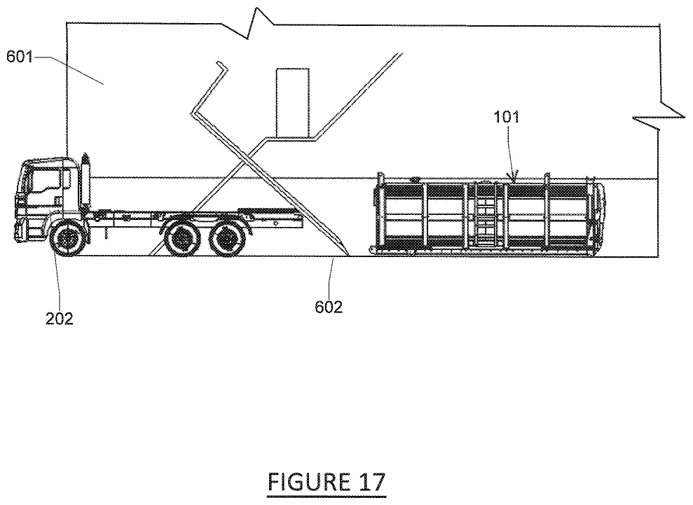

FIG. 17 is a perspective view of the slurry box 101 and vehicle 202. next to a building 601. The slurry box 101 has been placed by the vehicle 202 on the ground surface 602.

While various inventive aspects, concepts and features of the general inventive concepts are described and illustrated herein in the context of various exemplary embodiments, these various aspects, concepts, and features may be used in many alternative embodiments, either individually or in various combinations and sub-combinations thereof.

Unless expressly excluded herein all such combinations and sub-combinations are intended to be within the scope of the general inventive concepts. Still further, while various alternative embodiments as to the various aspects, concepts, and features of the inventions (such as alternative materials, structures, configurations, methods, devices and components, alternatives as to form, fit and function, and so on) may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the general inventive concepts even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

1. A system for transporting slurry cuttings for disposal between an oil rig site and a disposal facility, the system comprising:
a slurry box comprised of a structure that contains a vacuum tank that can hold a vacuum pressure, the vacuum tank comprises an inlet port and a vacuum port, the slurry box positioned to receive slurry cuttings at an oil rig site expressed from an oil rig through a slurry cutting outlet connected to the inlet port in response to a vacuum connected to the vacuum port at the oil rig site such that the slurry cuttings are expressed into the vacuum tank when under the vacuum pressure from the vacuum source, the vacuum source disconnected from the vacuum port when the vacuum tank is filled to a desired level with slurry cuttings; that are expressed into the vacuum tank when under the vacuum pressure;
wherein the slurry box is sized to be unloaded and loaded from a vehicle, the vehicle operable to transport the slurry box between the oil rig site and a disposal facility at which a vertical tailgate of the slurry box is opened vertically to dump the slurry cuttings from the vacuum tank by tilting the slurry box relative to the ground when the vertical tailgate is open.

2. The system of claim 1, further comprising a second slurry box, the slurry box is stackable upon a second slurry box to form a slurry box stack.

3. (canceled)

4. The system of claim 1, wherein the vehicle is a roll-off vehicle.

5. The system of claim 1, wherein the vacuum source is a vacuum pump.

6. The system of claim 1, wherein the vehicle is a truck-trailer.

7. (canceled)

8. The system of claim 2, wherein the oil rig site further comprises a storage location to place the slurry box stack.

9. (canceled)

10. The system of claim 1, wherein the slurry box further comprising a hook point to which a cable from the vehicle is attached to transit the slurry box onto the vehicle via a wheel set on the structure.

11. The system of claim 1, wherein the slurry box is unloaded at the disposal facility by first draining unconstrained fluid in the slurry cuttings by opening a port of the vacuum tank.

12. The system of claim 1, wherein the slurry box further comprising a power unit within a mechanical bay of the slurry box, the power unit in communication with a system of warming tubes in the vacuum tank to heat the slurry cuttings in the vacuum tank to a temperature above freezing.

13. The system of claim 12, wherein the power unit is removable from the mechanical bay.

14. (canceled)

15. The system of claim 13, wherein the power unit is adapted to heat a fluid which is circulated through the system of warming tubes producing a heated fluid flow.

16. A system for transporting slurry cuttings for disposal, the system comprising:
a slurry box that is stackable upon a second slurry box to form a slurry box stack, the slurry box comprised of a structure that contains a vacuum tank, a power unit, a system of warming tubes, a mechanical bay, and a vertical tailgate, the vacuum tank comprises an inlet port, and a vacuum port, the vertical tailgate pivotable to open and close vertically to dump the slurry cuttings, the power unit adapted to heat a fluid distributed through the system of warming tubes to heat the slurry cuttings in the slurry box to a temperature above freezing;
a disposal facility at which the vertical tailgate of the slurry box is opened to dump the slurry cuttings from the vacuum tank by tilting the slurry box relative to the ground;
a vacuum source connectable to the vacuum port when charging the vacuum tank while the vacuum tank is fluidly sealed from atmosphere;
an oil rig site comprising a slurry cutting outlet, the slurry cuttings expressed from the oil rig through the slurry cutting outlet, the slurry cutting outlet fluidly sealed to the inlet port when the vacuum source is connected to the vacuum port, the slurry cuttings expressed into the vacuum tank when the vacuum tank is under the vacuum pressure, the vacuum source disconnected from the vacuum tank when the vacuum tank is filled to a desired level with slurry cuttings;
a storage location at the oil rig site to place the slurry box stack; and
a vehicle, the slurry box sized to be unloaded and loaded from the vehicle, the vehicle operable to transport the slurry box between the oil rig site and the disposal facility.

17. The system of claim 1, wherein the vertical tailgate is attached to the structure with at least one tailgate hinge.

18. The system of claim 17, further comprising a hydraulic cylinder attached to the tailgate and the structure around the vacuum tank, the hydraulic cylinder operable to open the tailgate.

19. The system of claim 1, further comprising removing the slurry box from a stack of slurry boxes.

20. The system of claim 1, further comprising stacking the slurry box onto a stack of slurry boxes.

21. The system of claim 20, wherein the structure facilities vertical stacking.

22. The system of claim 21, further comprising a wheel set on the structure.

23. The system of claim 16, wherein the vertical tailgate is attached to the structure with at least one tailgate hinge.

24. The system of claim 23, further comprising a hydraulic cylinder attached to the tailgate and the structure around the vacuum tank, the hydraulic cylinder operable to open the tailgate.

25. The system of claim 16, wherein each slurry box is 2.26 meters (89 inches) wide by 7.37 meters (290 inches) long.

26. The system of claim 16, wherein the vehicle is a roll-off vehicle.

27. The system of claim 16, wherein the vehicle is a truck-trailer.

28. (canceled)
